(19) United States
(12) Patent Application Publication
(10) Pub. No.: US 2025/0053009 A1
(43) Pub. Date: Feb. 13, 2025

(54) SHAPED COLOR-ABSORBING REGIONS FOR WAVEGUIDES

(71) Applicant: Magic Leap, Inc., Plantation, FL (US)

(72) Inventors: Vikramjit Singh, Pflugerville, TX (US); Matthew C. Traub, Plantation, FL (US); Marlon Edward Menezes, Austin, TX (US); Yingnan Liu, Plantation, FL (US); Frank Y. Xu, Austin, TX (US)

(21) Appl. No.: 18/718,675

(22) PCT Filed: Dec. 16, 2022
(86) PCT No.: PCT/US2022/053225

§ 371 Date: Jun. 11, 2024

Related U.S. Application Data
(60) Provisional application No. 63/291,284, filed on Dec. 17, 2021.

(51) Int. Cl. G02B 27/01

(52) U.S. Cl. CPC G02B 27/0172; G02B 2027/0112

(57) ABSTRACT

A waveguide stack having color-selective regions on one or more waveguides. The color-selective regions are configured to absorb incident light of a first wavelength range in such a way as to reduce or prevent the incident light of the first wavelength range from coupling into a waveguide configured to transmit a light of a second wavelength range.

### CROSS-REFERENCE TO RELATED APPLICATION

This application claims the benefit of U.S. Patent Application No. 63/291,284 filed on Dec. 17, 2021, which is incorporated by reference herein in its entirety.

### TECHNICAL FIELD

This invention relates to shaped color-absorbing regions for waveguides, waveguides with shaped color-absorbing regions, augmented reality (AR)/mixed reality (MR) applications including color-selective waveguides with shaped color-absorbing regions, and methods of fabricating these regions, waveguides, and applications.

### BACKGROUND

Typically, augmented reality (AR)/mixed reality (MR) eyepiece stacks are composed of separate red (R), green (G), blue (B) waveguide layers stacked together with gaps of a few tens of microns between the successive layers. Multi-pupil liquid crystal on silicon (LCOS) projectors are designed to direct light from each color into the respective incoupling grating (ICG) (e.g., green light into the ICG of the green waveguide layer). However, stray light (often from diffraction at the LCOS) from the wrong color can propagate into a neighboring ICG due to the necessary close proximity of the ICGs in the super-pupil. The stray light can induce ghost images or reduce optical properties such as contrast.

In some cases, an eyepiece can be patterned (e.g., with one or more light diffractive structures), such that it projects an image according to a particular focal depth. For an example, to a user viewing a patterned eyepiece, the projected image can appear to be a particular distance away from the user.

Further, multiple eyepieces can be used in conjunction to project a simulated three-dimensional image. For example, multiple eyepieces can be layered one atop another, with each eyepiece having a different pattern and each eyepiece projecting a different depth layer of a volumetric image. Thus, the eyepieces can collectively present the volumetric image to the user across three-dimensions. This can be useful, for example, in presenting the user with a “virtual reality” or “augmented reality” environment.

### SUMMARY

Embodiments of the present disclosure are generally directed to shaped color-absorbing regions for waveguides, waveguides with shaped color-absorbing regions, augmented reality (AR)/mixed reality (MR) applications including color-selective waveguides with shaped color-absorbing regions, and methods of fabricating these regions, waveguides, and applications. As used herein, “color-selective” and “color-absorbing” generally refer to “wavelength-selective” and “wavelength-absorbing,” respectively, all of which terms are used interchangeably. A composition of the color-absorbing regions can be selected to absorb all or a portion of light in the visible region. In some examples, a color-absorbing region is black (i.e., absorbs all visible wavelengths), blue (i.e., absorbs green and red wavelengths), green (i.e., absorbs blue and red wavelengths), red (i.e., absorbs blue and green wavelengths). In another example, a color-absorbing region includes a combination of red, green, and blue dye or pigmented polymer that is not black, but absorbs all wavelength ranges of visible light that is incident on the waveguide.

Innovative methods described herein include fabricating shaped color-absorbing regions using ultraviolet (UV) curable resin dispensed over nanostructures in and about the input/combining or output coupling regions of eyepiece waveguides. The resin can be dispensed within a controlled volume, for example, in pre-existing nanostructures (e.g., gratings imprinted using nanoimprint lithography) in an area adjacent to an input coupling (IC) super pupil area. The color-absorbing regions of embodiments described herein absorb stray light from the illumination of one or more colors into an IC pupil configured for a color other than the one or more colors absorbed by the color-absorbing region(s).

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a waveguide stack comprising:
a first waveguide comprising a first input coupler configured to couple light in a first wavelength range into the first waveguide;
a second waveguide coupled to the first waveguide and comprising a second input coupler configured to couple light in a second wavelength range into the second waveguide;
a first color-selective region on a side of the first waveguide opposite that of the first input coupler, wherein the first color-selective region is configured to absorb incident light in the second wavelength range, thereby preventing the incident light in the second wavelength range from entering the first waveguide through the first input coupler; and
a second color-selective region on a side of the second waveguide opposite that of the second input coupler, wherein the second color-selective region is configured to absorb incident light in the first wavelength range, thereby preventing the incident light in the first wavelength range from entering the second waveguide through the second input coupler.

Embodiment 2 is the waveguide stack of embodiment 1, further comprising:
a third waveguide coupled to the second waveguide and comprising a third input coupler configured to couple light in a third wavelength range into the third waveguide; and
a third color-selective region on a side of the third waveguide opposite that of the second input coupler, wherein the third color-selective region is configured to absorb incident light in the second wavelength range, thereby preventing the incident light in the second wavelength range from entering the third waveguide through the third input coupler.

Embodiment 3 is the waveguide stack of embodiments 1 or 2, further comprising a fourth color-selective region, on the side of the second waveguide opposite that of the second input coupler, wherein the fourth color-selective region is configured to absorb incident light in the third wavelength range, thereby preventing the incident light in the third wavelength range from entering the second waveguide through the second input coupler.

Embodiment 4 is the waveguide stack of any one of embodiments 1 through 3, wherein the first color-selective region comprises a polymeric region configured to absorb incident light in the second wavelength range.

Embodiment 5 is the waveguide stack of embodiment 4, wherein the polymeric region has a shape and a size determined by an imprinted region on the side of the first waveguide.

Embodiment 6 is the waveguide stack of embodiment 5, wherein the imprinted region comprises protrusions and recessions.

Embodiment 7 waveguide stack of any one of embodiments 4 through 6, wherein a shape of the imprinted region is rectangular, arcuate, chevron-shaped, or hourglass-shaped.

Embodiment 8 is the waveguide stack of any one of embodiments 1 through 7, wherein an interface between the first color-selective region and the first waveguide is patterned.

Embodiment 9 is the waveguide stack of embodiment 8, wherein a side of the first color-selective region opposite the interface is convex, planar, or patterned.

Embodiment 10 is the waveguide stack of embodiment 9, wherein the side of the first color selective region opposite the interface is anti-reflective.

Embodiment 11 is an eyepiece comprising the waveguide stack of any one of embodiments 1 through 10.

Embodiment 12 is a method of forming a wavelength-selective region on a waveguide, the method comprising:
forming a recession on a portion of a waveguide proximate an input coupler, wherein the input coupler is configured to couple light in a selected wavelength range into the waveguide;
disposing a color-selective polymerizable composition in the recession; and
polymerizing the polymerizable composition to yield the wavelength-selective region, wherein the wavelength-selective region is configured to absorb incident light on the input coupler other than light in the selected wavelength range.

Embodiment 13 is the method of embodiment 12, wherein disposing the color-selective polymerizable composition in the recession comprises a continuous or discrete deposition of the polymerizable composition.

Embodiment 14 is the method of embodiment 12 or 12, wherein the recession comprises a nanopattern.

Embodiment 15 is the method of embodiment 14, wherein the nanopattern is selected to direct flow of the polymerizable composition on the waveguide.

Embodiment 16 is the method of any one of embodiments 12 through 15, wherein the recession is rectangular, arcuate, chevron-shaped, or hourglass-shaped.

Embodiment 17 is method of any one of embodiments 12 through 16, further comprising, before polymerizing the polymerizable composition, contacting the polymerizable composition with a template.

Embodiment 18 is the method of embodiment 17, wherein the template is nanopatterned or blank.

Embodiment 19 is the method of any one of embodiments 12 through 18, wherein the wavelength-selective region separates the input coupler from an additional input coupler.

Embodiment 20 is the method of any one of embodiments 12 through 19, wherein the recession comprises a patterned perimeter configured to retain the polymerizable composition in the recession.

Embodiment 21 is the method of any one of embodiments 12 through 20, wherein the recession comprises protrusions configured to direct a flow of the polymerizable composition in the recession.

Advantages of the color-absorbing regions described herein include reduction of color cross-coupling into a waveguide layer of a specific color so as to not in-couple and thus out-couple unwanted colors, which can cause image ghosting and issues in contrast and reduce sharpness. The resulting waveguides and eyepieces allow a configuration with a smaller profile, in which the illumination source and the IC pupils are positioned close together. With the illumination source and the IC pupils positioned close together, the light source can be packed in a smaller volume, and the AR/MR device can slimmer and more lightweight than otherwise possible.

The details of one or more embodiments are set forth in the accompanying drawings and the description below. Other features and advantages will be apparent from the description and drawings, and from the claims.

### BRIEF DESCRIPTION OF DRAWINGS

FIG. 1A is a side cross-sectional view of a waveguide (eyepiece) stack with color cross-coupling to input couplers (ICs) from illumination. FIGS. 1B-1E are top views of super pupils with ICs that demonstrate cross-coupling of illumination.

FIG. 2A is a side cross-sectional view of a waveguide (eyepiece) stack with color-absorbing regions to avoid cross-coupling of illumination into the ICs. FIGS. 2B-2F are top views of super pupils with color-absorbing regions that block cross-coupling of illumination.

FIG. 3A depicts application of successive resin drops to patterned recesses in a substrate. FIG. 3B depicts application of resin drops by a continuous system to patterned recesses in a substrate.

FIGS. 4A and 4B are side and top cross-sectional views, respectively, of resin drops disposed on a blank substrate.

FIGS. 5A and 5B are side and top cross-sectional views, respectively, of resin drops disposed on a substrate with nanopatterned features. FIG. 5C depicts a launch direction example.

FIGS. 6A and 6B are side and top cross-sectional views, respectively, of resin drops disposed on a substrate with nanopatterned features rotated 12° counterclockwise with respect to the nanofeature orientation of FIG. 5B. FIG. 6C depicts a launch direction example.

FIGS. 7A and 7B are side and top cross-sectional views, respectively, of resin drops disposed on a substrate with nanopatterned features rotated 22° counterclockwise with respect to the nanopatterned feature orientation of FIG. 5B. FIG. 7C depicts a launch direction example.

FIGS. 8A-8E are top views of various sizes and shapes of nanopatterned features formed on a waveguide substrate and filled with resin to yield color-absorbing regions. FIG. 8F shows top views of illumination blocked from ICs by the color-absorbing regions of FIGS. 8A, 8B, and 8E.

FIGS. 9A and 9B depict drops that have been inkjetted onto blank substrates and contacted with nanopatterned superstrate templates having 0° and 120° orientations respectively.

FIGS. 10A-10F are side cross-sectional views of a portion of a waveguide stack with anti-reflective color-absorbing regions on world side and eye surfaces of the waveguide stack.

FIGS. 11A-11F are top and side cross-sectional views of color-absorbing regions on various substrates.

FIG. 12A depicts an augmented reality (AR)/mixed reality (MR) wearable eyepiece. FIG. 12B is a top view of a waveguide stack with a super pupil. FIG. 12C is an exploded view of the super pupil area and the LCOS image projection.

FIGS. 13A-13C depict various anti-reflective gratings defined lithographically and patterned with, for example, an IC diffractive grating on one or both sides the wafer to guide color-absorbing resin into specific orientations.

FIGS. 14A-14B depict an embodiment of a patterned super pupil and color-absorbing regions before and after the color-absorbing regions are filled with color-absorbing resin, respectively.

FIGS. 15A-15B depict an embodiment of a super pupil with patterned ICs, illumination sources, and color-absorbing regions before and after the color-absorbing regions are filled with color-absorbing resin, respectively.

FIGS. 16A-16B depict an embodiment of a patterned super pupil and blank color-absorbing regions before and after the color-absorbing regions are filled with color-absorbing resin, respectively.

FIGS. 17A-17B depict an embodiment of a super pupil with patterned ICs, illumination sources, and blank color-absorbing regions before and after the color-absorbing regions are filled with color-absorbing resin, respectively.

FIGS. 18A-18D depict spreading of a single drop of color-absorbing resin in a color-absorbing region of a super pupil.

FIGS. 19A-19D depict spreading of multiple drops of color-absorbing resin in a color-absorbing region of a super pupil.

FIGS. 20A-20B are side cross-sectional views of waveguide stacks with and without spacers between the waveguides, respectively.

### DETAILED DESCRIPTION

Current in-coupling grating (ICG) or in-coupler (IC) designs typically have limited wavelength selectivity, such that stray light of an undesired wavelength is sometimes injected into the waveguide and undesirably coupled into the waveguide, thereby degrading waveguide performance. In one example, a green ICG diffracts some portion of blue and red light, which gets coupled into the waveguide as “stray light.” The presence of stray light in a waveguide can degrade its optical performance. In some cases, light at the edge of a waveguide is back-reflected or back-scattered into an eyepiece, thereby eroding contrast. In addition, current construction of the super pupil area for input coupling does not allow pupil sizes to be brought closer, as this can result in unwanted colors in-coupling in waveguide layers meant for other colors (i.e., color cross-coupling). Color cross-coupling can result in a virtual image having a secondary image projected of a single color, where the secondary image does not line up with the primary image.

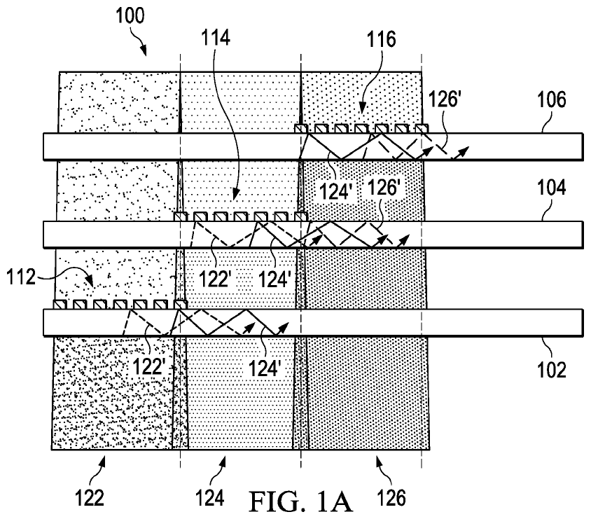

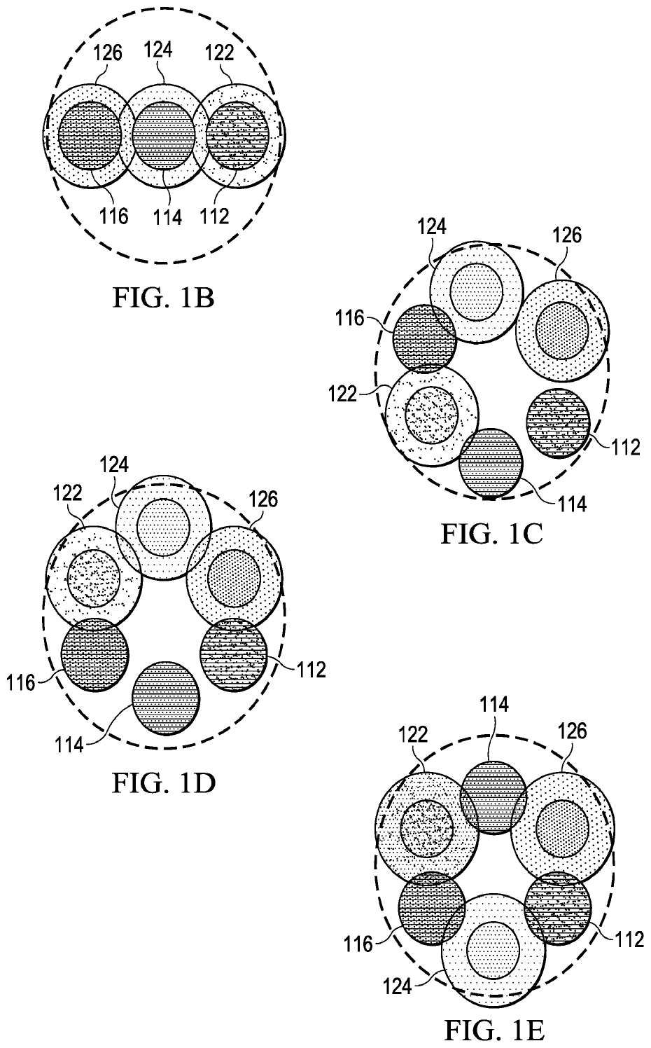

FIG. 1A is a side cross-sectional view of waveguide stack 100 with red, green, and blue waveguides 102, 104, 106 having ICs 112, 114, 116, respectively, and with cross-coupling into ICs 112, 114, 116 from illumination incident on waveguide stack 100. Red light 122 directed toward IC 112 couples into red waveguide 102, and propagates as red light 122′ though red waveguide 102 to a combined pupil expander (not shown). Green light 124 directed toward IC 114 couples into green waveguide 104, and propagates as green light 124′ though green waveguide 104 to a combined pupil expander (not shown). Blue light 126 directed toward IC 116 couples into blue waveguide 106, and propagates as blue light 126′ though blue waveguide 106 to a combined pupil expander (not shown). Red light 122 also couples into green waveguide 104, and propagates as red light 122′ though green waveguide 104. Green light 124 also couples into red waveguide 102 and blue waveguide 106, and propagates as green light 124′ through red waveguide 102 and blue waveguide 106. Blue light 126 also couples into green waveguide 104, and propagates as blue light 126′ through green waveguide 104. This cross-coupling (red light 122 coupled through green IC 114 into green waveguide 104; green light 124 coupled into red waveguide 112 through red IC 112 and coupled into blue waveguide 106 through blue IC 116; and blue light 126 coupled into green waveguide 104 through green IC 114) degrades the optical performance of eyepiece stack 100.

FIGS. 1B-1E are top views of super pupils with ICs that demonstrate cross-coupling of illumination. The pupil layout of FIG. 1B corresponds to the pupil layout of FIG. 1A. In FIG. 1B, red light 122, green light 124, and blue light 126 are centered about red IC 112, green IC 114, and blue IC 116, respectively. Red light 122 impinges on red IC 112 and green IC 114. Green light 124 impinges on red IC 112, green IC 114, and blue IC 116. Blue light 126 impinges on green IC 114 and blue IC 116. In the pupil layout of FIG. 1C, red light 122 is coupled into red IC 112, green IC 114, and blue IC 116. Green light 124 is coupled into green IC 114 and blue IC 116. Blue light 126 is coupled into red IC 112 and blue IC 116. In the pupil layout of FIG. 1D, red light 122 impinges on red IC 112, green IC 114 and blue IC 116. In the pupil layout of FIGS. 1C-1E, unwanted light is similarly coupled into red IC 112, green IC 114, and blue IC 116.

Embodiments described in this disclosure combine the use of UV curable resin inkjet and nanoimprinting (e.g., Jet and Flash Imprint Lithography, J-FIL™) with ultrafine control on thickness and ability to pattern features at the sub-5 nm scale with the ability to absorb specific wavelengths of light. These embodiments can reduce the wearable form factor of waveguides (e.g., eyepieces) from a systems level (waveguide+projector layout) by giving the design more flexibility and freedom in terms of enabling inline single pupil ICs or multi-split pupil ICs which are closer together. These embodiments can allow positioning of two or more IC pupils closer to each other. This is can be achieved, for example, by having area or site-specific imprints with certain UV curable resins dispensed using on drop-on-demand technology via single or multipoint inkjet heads. Such resin film regions (e.g., dots, pads, patches, etc.) can have specific absorption for desired wavelengths of light, thereby reducing or preventing undesired light from propagating into a waveguide of a different color, and thus not affecting the virtual image by out coupling towards the user. This precise area patterning with nanoscale control on the shape and location of micro- or nanofeatures can be applied to any surface of a rigid or flexible substrate composed of inorganic materials, organic materials, metallic materials, or a combination thereof.

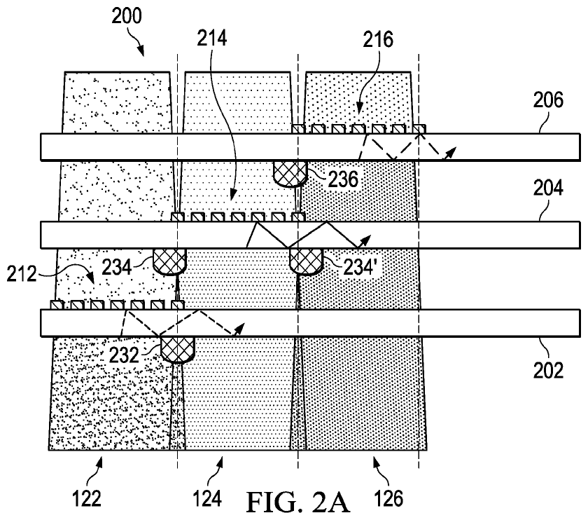

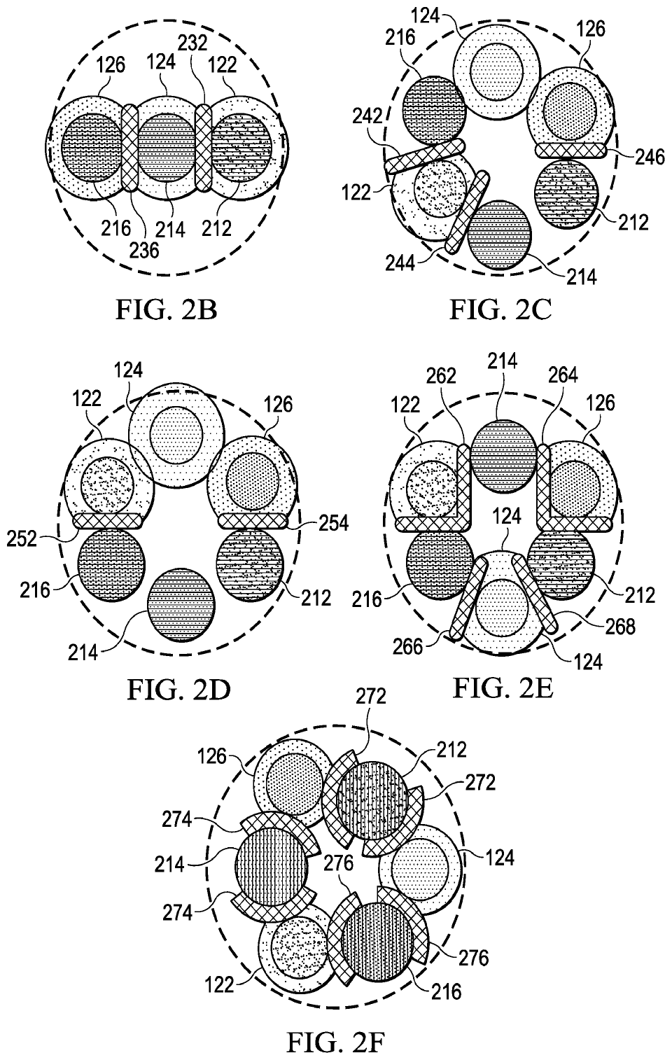

FIG. 2A is a side cross-sectional view of a waveguide stack 200 configured to block cross-coupling of illumination into the ICs. Red waveguide 202, green waveguide 204, and blue waveguide 206 have red IC 212, green IC 214, and blue IC 216, respectively. Color-absorbing region 232 is positioned on red waveguide 202 opposite red IC 212, such that illumination other than red light impinging on the red IC is absorbed proximate the red IC, and green and blue light are blocked from coupling into red waveguide 202. Color-absorbing regions 234, 234′ are positioned on green waveguide 204 opposite green IC 214, such that illumination other than green light impinging on the green IC is absorbed proximate the green IC. Color-absorbing region 236 is positioned on blue waveguide 206 opposite blue IC 216, such that illumination other than blue light impinging on the blue IC is absorbed proximate the blue IC, and red and green light are blocked from being coupled into blue waveguide 206.

FIGS. 2B-2F are top views of super pupils with color-absorbing regions that block cross-coupling of illumination. The pupil layouts of FIGS. 2B-2E correspond to the pupil layouts of FIGS. 1B-1E, respectively. The pupil layout depicted in FIG. 2B corresponds to the pupil layout depicted in FIG. 2A. In FIG. 2B, red light 122, green light 124, and blue light 126 are centered about red IC 212, green IC 214, and blue IC 216, respectively. Color-absorbing region 232 (superimposed with color-absorbing region 234) is positioned between red IC 212 and green IC 214, absorb red and green light, thereby blocking red light 122 from coupling into green IC 214 and green light 124 from coupling into red IC 212. Color-absorbing regions 236 (superimposed with color-absorbing region 234′) are positioned between green IC 214 and blue IC 216, and absorb green light 124 and blue light 126, thereby blocking green light 124 from coupling into blue IC 216 and blue light 126 from coupling into green IC 214. In the pupil layout of FIG. 2C, color-absorbing regions 242 and 244 prevent unwanted red light 122 from coupling into blue IC 216 and green IC 214, respectively, and color-absorbing region 246 prevents unwanted blue light 126 from coupling into red IC 212. In the pupil layout of FIG. 2D, color-absorbing regions 252 and 254 prevent unwanted red light 122 and blue light 126 from coupling into blue IC 216 and red IC 212, respectively. In the pupil layout of FIG. 2E, color-absorbing regions 262, 264, 266, 268 prevent unwanted light from coupling into adjacent ICs. In the pupil layout of FIG. 2F, color-absorbing regions 272, 274, and 276 prevent unwanted light from coupling into adjacent couplers. In FIGS. 2C-2F, each color-absorbing region may be a superimposition of two or more color-absorbing regions.

The color-absorbing regions depicted in FIGS. 2A-2F can be applied to waveguide substrates with a controlled drop-on-demand dispense technique (inkjet drop-on-demand, or continuous inkjetting, atomization/spray, etc.) of color-absorbing resin. The color-absorbing resin can be disposed directly onto pre-patterned features (e.g., nanofeatures) pre-patterned in the waveguide substrates. The pre-patterned features are configured to direct flow of the resin to control coverage in a region on the substrate having selected size and shape. The pre-patterned features can be in the form of nanogratings having a thickness of 100 nm to 100 μm, with features having a pitch of 50 nm to 500 nm, a linewidth of 10 nm to 450 nm, and a height of 10 nm to 500. Capillary force directs the fluid flow along the direction of the nanogratings, which can be of various configurations, including straight, curved, stair-stepped (aliased), zig-zag, etc.

The color-absorbing resin can include UV and thermally curable crosslinking monomers and oligomers, with or without oxygen inhibitors. To make the color-absorbing resin, dye or pigment is typically premixed with solvent and resin, and a photoinitiator is added to yield the UV curable resin. The dye or pigment can be selected to absorb all or a portion of light in the visible region. In some examples, the dye or pigment is black (i.e., absorbs all visible wavelengths). In other examples, the dye or pigment is blue (i.e., absorbs green and red wavelengths), green (i.e., absorbs blue and red wavelengths), red (i.e., absorbs blue and green wavelengths), or any combination thereof. In particular, a color-absorbing region can include a combination of red, green, and blue dye or pigmented polymer that is not black, but all absorbs wavelength ranges of visible light that is incident on the waveguide.

After the UV curable resin is molded in a selected size and shape with a desired height (e.g., by nanofeautures on the substrate on which the color-absorbing material is dispensed), the resin is cured. In some examples, the resin includes epoxy vinyl esters, where the vinyl monomer can be methyl methacrylate, and difunctional or trifunctional vinyl monomers (diacrylates, triacrylates, dimethacrylates, etc.) with or without aromatic molecules in the monomer etc., and generally has an index in a range from about 1.5 to about 1.7. In some cases, the resin includes the application of a cyclic aliphatic epoxy containing UV and/or heat curable resin. A UV cationic photoinitiator and co-reactant can be added to promote UV curing in ambient. UV acrylate coatings and films tend to suffer from oxygen inhibition during ambient curing. During curing, oxygen will react with acrylate radicals at the surface to generate peroxide radicals, which are inactive. This will effectively stop the chain reaction and result in a sticky, wet surface after UV exposure, which is not desirable. Viscosity of the material can be in a range of about 10 cPs to about 100,000 cPs to about 500,000 cPs.

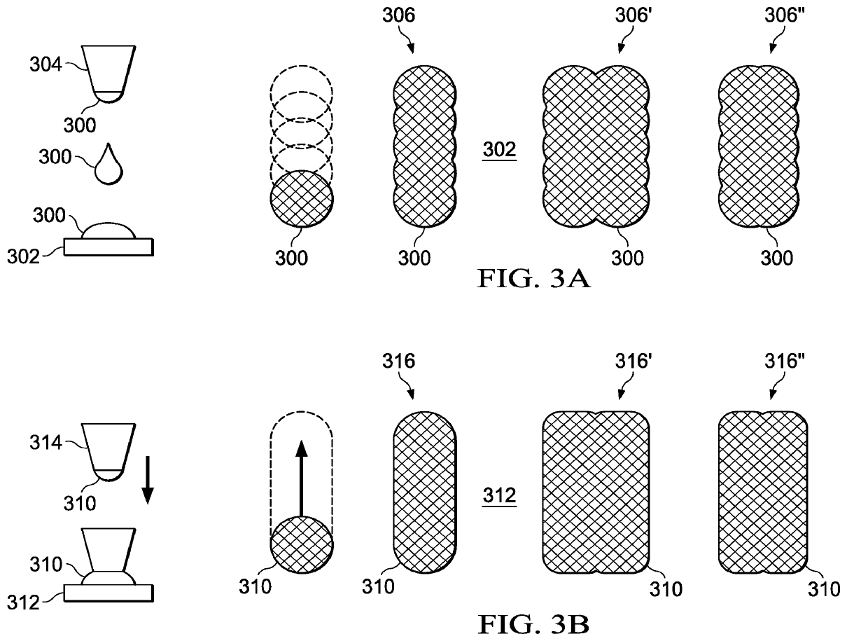

FIG. 3A depicts application of resin 300 to substrate 302 by a drop-on-demand system with nozzle 304. Successive drops of resin 300 can be applied to patterned features in substrate 302 to fill recesses in the pattern. The flow of resin 300 in recesses of the patterned feature is directed by capillary force along a length of recesses in the patterned features to yield structures 306, 306′, 306″. Drops of resin 300 can be applied as needed to fill the pattern (e.g., two or more adjacent rows of resin drops can be applied to fill recesses in the pattern). When recesses in the pattern are filled with resin, the resin can be solidified by exposure to ultraviolet (UV) light to yield a color-absorbing feature on the substrate.

FIG. 3B depicts application of resin 310 to substrate 312 by nozzle 314 of a continuous inkjetting system or positive pressure continuous flow-through system, such as a syringe pump. A continuous stream of resin 310 is applied to a patterned feature to fill recesses in the pattern. Continuous streams of resin 310 can be applied to fill the patterned feature (e.g., two or more adjacent row of resin can be applied to a feature to fill recesses in the pattern) to yield structures 316, 316′, 316″. When recesses in the pattern are filled with resin, the resin can be solidified by exposure to ultraviolet (UV) light to yield a color-absorbing feature on a waveguide substrate.

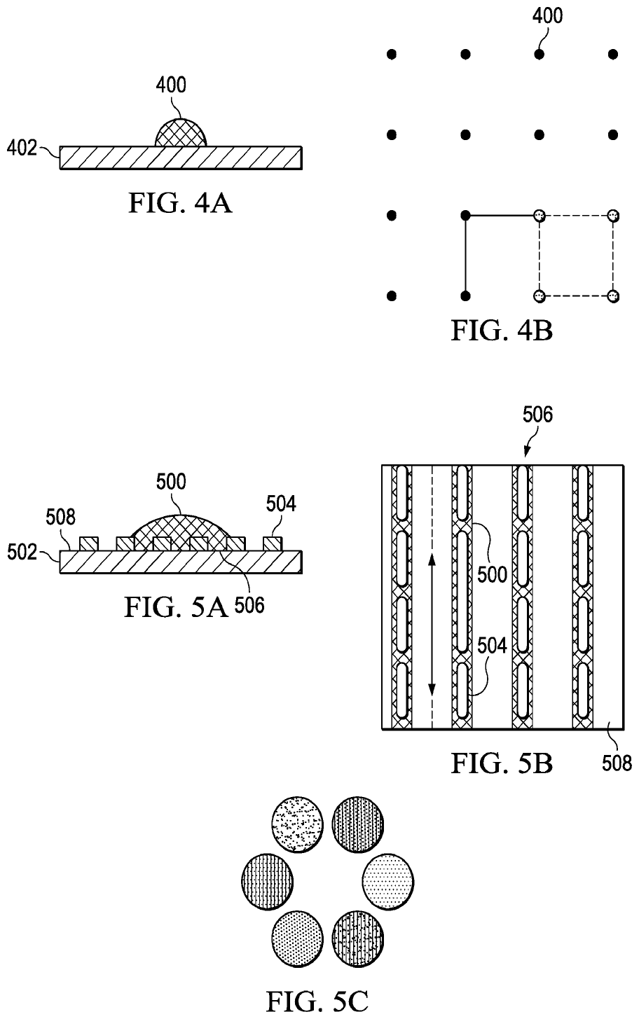

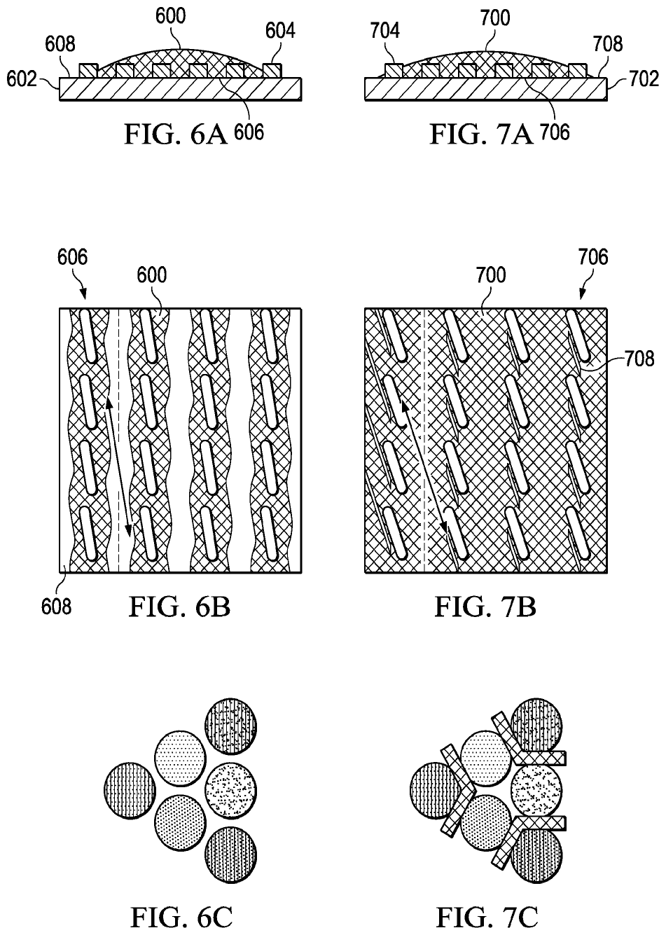

FIGS. 4A-4B, 5A-5B, 6A-6B, and 7A-7B show side cross-sectional and top views, respectively, of color-absorbing resin disposed by a drop-on-demand process on a blank or patterned substrate. The cross-sectional views show spreading of a single resin drop on the surface of the substrate. The top views show spreading of multiple resin drops on the surface of the substrate, and the extent to which the resin drops merge as a result of spreading. In FIG. 4B, the substrate is a blank (e.g., flat) substrate (e.g., a blank silicon wafer). FIGS. 5B, 6B, and 7B depict resin drops after spreading (before contact of a template with the substrate) on a patterned substrate with 130 nm pitch nanofeatures (e.g., nanogratings) extending from top to bottom of the drawing as shown. The nanofeatures in FIG. 5B are aligned (i.e., have no rotation). Each nanofeature in FIG. 6B is rotated 12° counterclockwise with respect to the nanofeature orientation of FIG. 5B. Each nanofeature in FIG. 7B is rotated 22° counterclockwise with respect to the nanofeature orientation of FIG. 5B. FIGS. 5C, 6C, and 7C provide launch direction examples.

FIG. 4A shows the resin 400 disposed as a drop on blank substrate 402. Resin 400 has a high contact angle, indicative of relatively little spreading. Resin 400 is one of multiple resin drops disposed in a grid as shown in FIG. 4B. In this example, resin drops 400 have a volume of about 4 pL to about 6 μL and a spacing (center to center) on the surface of substrate 402 of 176 μm. As shown in FIG. 4B, resin 400 remains as discrete drops that do not merge together.

FIGS. 5A and 5B are cross-sectional and top views, respectively, of resin 500 disposed on substrate 502 with patterned features 504. Patterned features 504 are in the form of a grating. FIG. 5A shows resin 500 disposed as a drop and spread over several rows of the grating, with a contact angle of resin 500 on substrate 502 than that of resin 400 on substrate 402. FIG. 5B shows resin 500 spread along patterned features 504 by capillary action to cover portions 506 of the substrate, leaving portions 508 of the substrate exposed.

FIGS. 6A and 6B are cross-sectional and top views, respectively, of resin drops 600 disposed on substrate 602 with patterned features 604. Patterned features 604 are in the form of a grating, with each nanofeature rotated 12° counterclockwise with respect to patterned features 504 of substrate 502. FIG. 6A shows resin 600 disposed as a drop and spread over several rows of the grating, with a contact angle of resin drop 600 on substrate 602 less than that of resin drop 500 on substrate 502. FIG. 6B shows resin 600 spread along patterned features 604 by capillary action to cover portions 606 of the substrate, leaving portions 608 of the substrate exposed. The orientation of patterned features in FIG. 6B promotes greater capillary action than that of features 504, thereby achieving greater coverage of substrate 602.

FIGS. 7A and 7B are cross-sectional and top views, respectively, of resin 700 disposed on substrate 702 with patterned features 704. Patterned features 704 are in the form of a grating, with each nanofeature rotated 22° counterclockwise with respect to patterned features 504 of substrate 502 (or 10° counterclockwise with respect to patterned features 604 of substrate 602). FIG. 7A shows resin 700 disposed as a drop spread over several rows of the grating, with a contact angle of resin drop 700 on substrate 702 less than that of resin drop 600 on substrate 602. FIG. 7B shows resin 700 spread along patterned features 704 by capillary action to cover portions 706 of the substrate, leaving portions 708 of the substrate exposed. The orientation of patterned features 704 promotes greater capillary action that that of features 604, thereby achieving greater coverage of substrate 702.

Comparison of FIGS. 5B, 6B, and 7B demonstrates that the shape and orientation of patterned features on a substrate can direct the flow of resin on a substrate to fill selected regions of the substrate. Thus, the shape and orientation of patterned features in a substrate can be selected to control coverage of the substrate by resin to achieve coverage in well-defined (shaped) regions of the substrate.

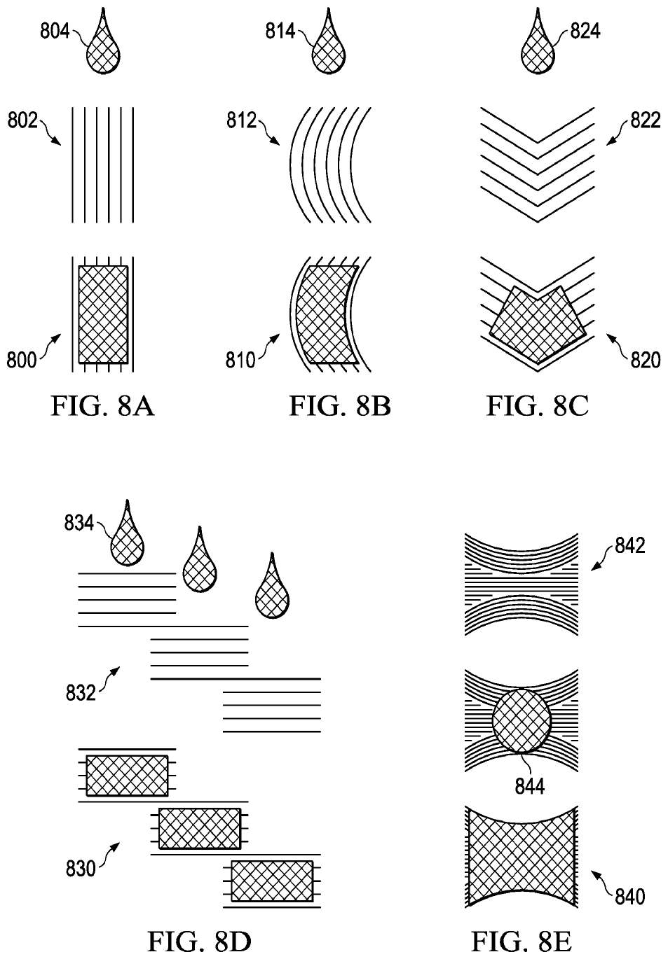

Nanopatterned features of various sizes and shapes formed on a waveguide substrate and filled with color-absorbing resin can be used to form color-absorbing regions on waveguide substrates. FIGS. 8A-8E depict examples of suitable shapes for color-absorbing regions. FIG. 8A depicts rectangular color-absorbing region 800 formed by filling rectangular nanopatterned feature 802 with color-absorbing resin 804. FIG. 8B depicts curved color-absorbing region 810 formed by filling curved (e.g., arcuate) nanopatterned feature 812 with color-absorbing resin 814. FIG. 8C depicts angled (e.g., chevron-shaped) color-absorbing region 820 formed by filling angled nanopatterned feature 822 with color-absorbing resin 824. FIG. 8D depicts a repeating (aliased) rectangular color-absorbing region 830 formed by filling repeating rectangular nanopatterned feature 832 with color-absorbing resin 834. FIG. 8E depicts hourglass color-absorbing region 840 formed by filling hourglass nanopatterned feature 842 with color-absorbing resin 844.

FIG. 8F depicts rectangular color-absorbing region 800, curved color-absorbing region 810, and hourglass color-absorbing region 840 between illumination source 850 and ICs 852, with illumination 854 traveling to output couplers.

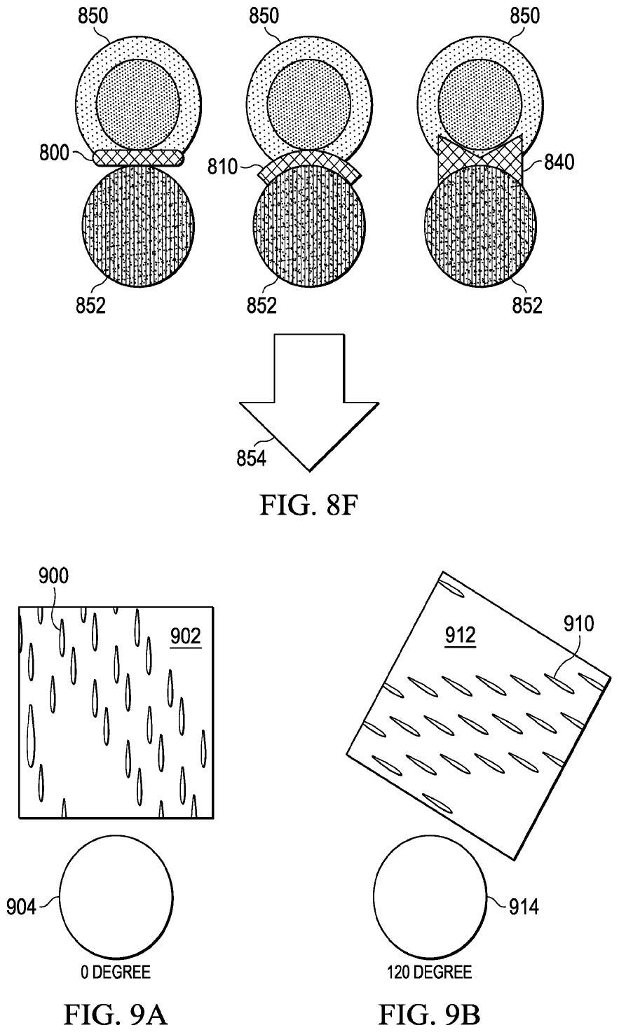

After color-absorbing resin has been disposed on a blank or nanopatterned substrate and before the resin is cured, the resin can be contacted with a superstrate (i.e., a template) having a blank or patterned surface. The superstrate can further confine the resin prior to curing. FIG. 9A is an image showing resin drops 900 that have been inkjetted onto blank substrate 902 and contacted with (i.e., shape-controlled) nanopatterned superstrate (template) 904. FIG. 9B is an image showing resins drop 910 that have been inkjetted onto blank substrate 912 and contacted with (i.e., shape-controlled) with nanopatterned superstrate (template) 914. Template 914 corresponds to a 120° clockwise rotation of template 902 or rotation of the substrate with respect to the gratings on the template.

Comparison of FIGS. 9A and 9B demonstrate control of dispensed curable resin by contact with nanofeature gratings going vertically (0°) in FIG. 9A and angled at 120° (clockwise from the vertical axis) in FIG. 9B. When a patterned template contacts the resin dispensed on a patterned substrate, the drop spread is initially channeled in a certain direction. This channeling can further promote resin spread along that direction, prevent the resin from spreading along the initial spread direction defined by the pattern on the substrate, or redirect the resin spread in another direction (e.g., impart an oblong elliptical shape). The pattern imprinted on the resin after UV or thermal curing by the template can also lead to creation of anti-reflective nanostructures, leading to more color-absorption and less stray light in the waveguide eyepiece stack's super-pupil area.

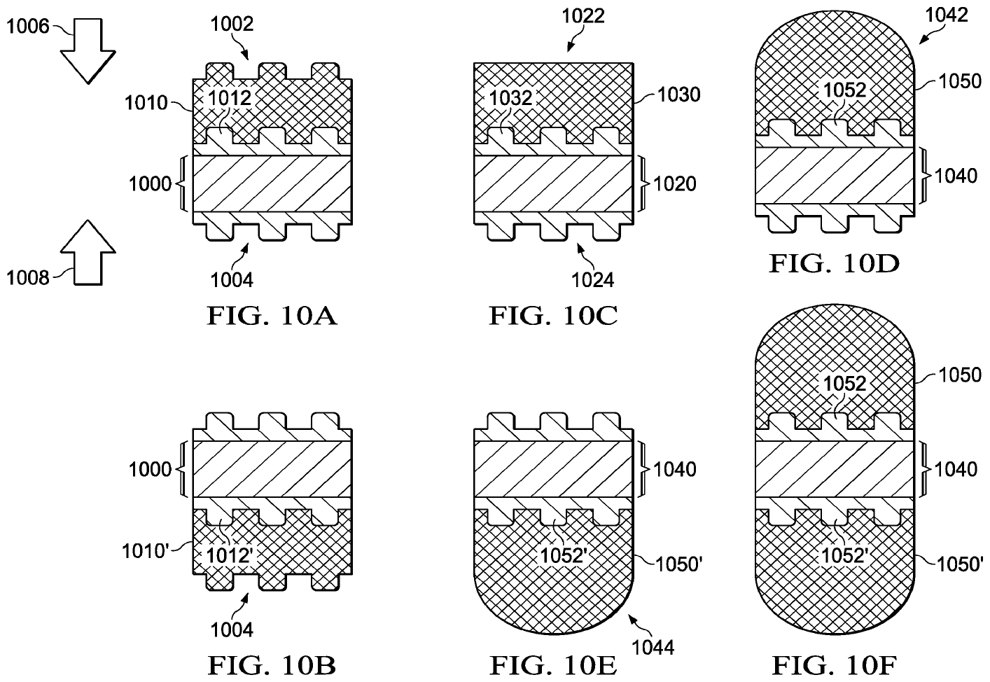

A color-absorbing layer formed on one or both of the eye side and world side of a waveguide (eyepiece) stack with a blank or patterned superstrate can provide an anti-reflective surface and thus further reduce angular reflection of stray light by the waveguide stack. FIGS. 10A-10F are side cross-sectional views of a portion of a waveguide stack with anti-reflective color-absorbing regions on world side and eye surfaces of the waveguide stack. FIG. 10A is a cross-sectional view of a portion of waveguide stack 1000 with world side surface 1002 and eye side surface 1004. Light 1006 incident on world side surface 1002 is directed toward the LCOS of waveguide stack 1000, and light 1008 from the LCOS is provided to the IC on the opposite of waveguide stack 1000. Anti-reflective nanopatterned color-absorbing region 1010 on world side surface 1002 is formed over nanopatterned features 1012. Nanopatterned features 1012 reduce back reflection and confine color-absorbing resin that forms color-absorbing region 1010. FIG. 10B is a cross-sectional view of a schematic of a portion of waveguide stack 1000 with anti-reflective nanopatterned color-absorbing region 1010′ on eye side surface 1004 formed over nanopatterned features 1012′. FIG. 10C is a cross-sectional view of a schematic of a portion of waveguide stack 1020 with world side surface 1022 and eye side surface 1024. Anti-reflective flat color-absorbing region 1030 on world side surface 1022 is formed over nanopatterned features 1032. FIG. 10D is a cross-sectional view of a schematic of a portion of waveguide stack 1040 with anti-reflective curved color-absorbing region 1050 formed over nanopatterned features 1052 on world side surface 1042. FIG. 10E is a cross-sectional view of a schematic of a portion of waveguide stack 1040 with anti-reflective curved color-absorbing region 1050′ formed over nanopatterned features 1052′ on eye side surface 1044. FIG. 10F is a cross-sectional view of a schematic of a portion of waveguide stack 1040 with anti-reflective curved color-absorbing regions 1050, 1050′ formed over nanopatterned features 1052, 1052′, respectively.

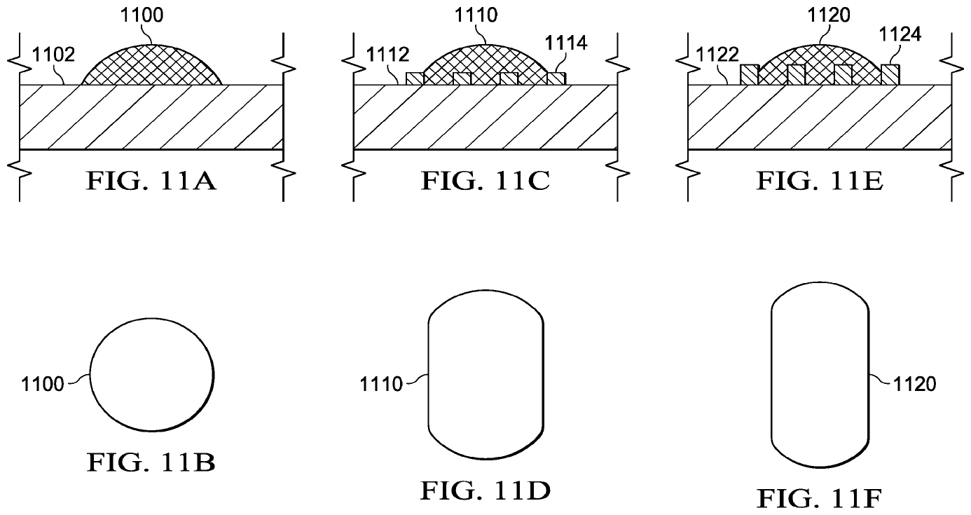

FIGS. 11A, 11C, and 11E are side cross-sectional views of color-absorbing regions on various substrates, and FIGS. 11B, 11D, and 11F are the corresponding top views. In FIG. 11A, color-absorbing resin drop 1100 is disposed on flat substrate 1102. FIG. 11B is top view of color-absorbing resin drop 1100 after spreading, demonstrating that the drop maintained a circular shape after spreading. In FIG. 11C, color-absorbing resin drop 1110 is disposed on substrate 1112 with nanofeatures 1114 having height of about 45 nm. FIG. 11D is a top view of color-absorbing resin drop 1110, demonstrating that the resin spread into an elongated shape between outer nanofeatures 1114. In FIG. 11E, color-absorbing resin drop 1120 is disposed on nanopatterned substrate 1122 with nanofeatures 1124 having a height of about 90 nm. FIG. 11F is top view of color-absorbing resin drop 1120 demonstrating that the resin spread into an elongated shape between outer nanofeatures 1124 with a width less than that of color-absorbing resin drop 1110, demonstrating that the color-absorbing resin spreads less (is more contained) on a surface with a deeper grating.

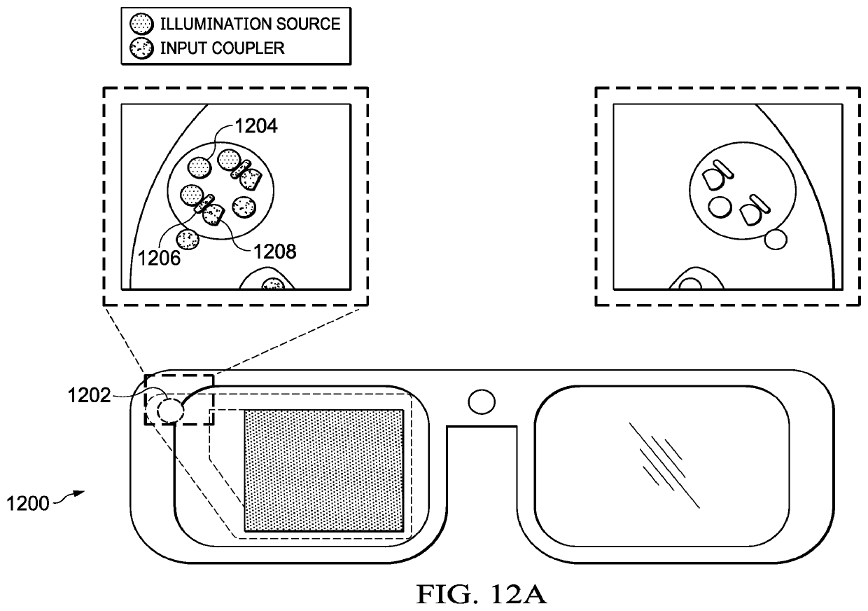

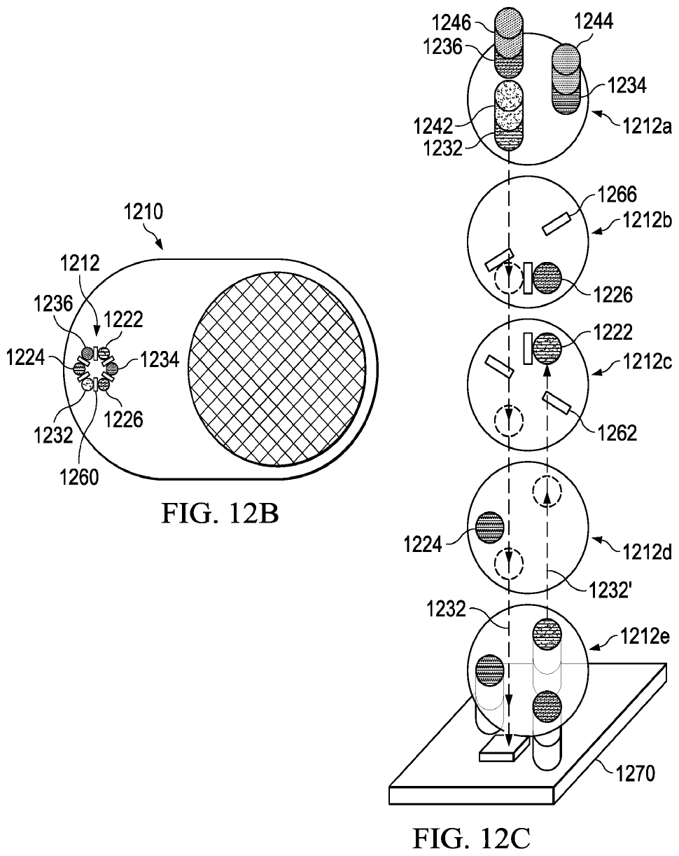

FIG. 12A depicts augmented reality (AR)/mixed reality (MR) wearable eyepiece stack 1200, which shows the super pupil area where the ICs are located. In this embodiment, the ICs are located on the temple side, and and the combined expander, combiner, and exit/output coupling element are located over the area covering the eye of the user. The inset shows an enlarged image of super pupil 1202 where the ICs are located, with RGB illumination sources 1204. Color-absorbing regions 1206 are positioned between RGB illumination sources 1204 and RGB ICs 1208. Each RGB coupler 1208 has a color-absorbing region 1206, which selectively absorbs certain wavelengths in order to prevent light from illumination source 1204 from coupling into the input coupler 1208 coming from the LED source on its way towards a light projection system (e.g., LCOS projector), which then gets coupled into each respective IC. Each RGB coupler 1208 has a color-absorbing anti-reflective layer on its world side surface. Color-absorbing regions 1206 and RGB ICs 1208 block cross-illumination from incoupling of undesired colors.

FIG. 12B shows a top view of waveguide stack 1210 having super pupil 1212. The inset shows an enlarged top view of super pupil 1212. A top view of super pupil 1212 shows RGB light 1232, 1234, 1236 from RGB illumination sources 1242, 1244, 1246 incident on super pupil 1212. Color absorbing regions 1260 are positioned between RGB ICs 1222, 1224, 1226 and regions upon which the RGB light 1232, 1234, 1236 is incident. FIG. 12C is an exploded view of super pupil 1212, with layers 1212a, 1212b, 1212c, 1212d, 1212e in waveguide stack 1210. RGB light 1232, 1234, 1236 from RGB illumination sources 1242, 1244, 1246 is incident on illumination side layer 1212a and travels through illumination side layer 1212a to blue waveguide layer 1212b with blue IC 1226 and color absorbing regions 1266, through blue waveguide layer 1212b to red waveguide layer 1212c with red IC 1222 and color absorbing regions 1262, through red waveguide layer 1212c to green waveguide layer 1212d with green IC 1224, and through green waveguide layer 1212d to LCOS side layer 1212e, then impinges on LCOS 1270. As depicted in FIG. 12C, red light 1232 from red illumination source 1242 travels through illumination side layer 1212a to blue waveguide layer 1212b. Red light 1232 passes between color absorbing regions 1266 which block red light 1232 from entering green IC 1224 and blue IC 1226. After passing through blue waveguide layer 1212b, red light 1232 passes through red waveguide layer 1212c, then green waveguide layer 1212d, and LCOS side layer 1212e, and impinges on LCOS 1270. Red light 1232′ from LCOS 1270 then travels through LCOS side layer 1212e to green waveguide layer 1212d, and through green waveguide layer 1212d to red waveguide layer 1212c, and is coupled into red waveguide layer 1212c through red IC 1222. Green light 1234 and blue light 1236 take similar paths from green illumination source 1244 and blue illumination source 1246 into green IC 1224 and blue IC 1226, respectively.

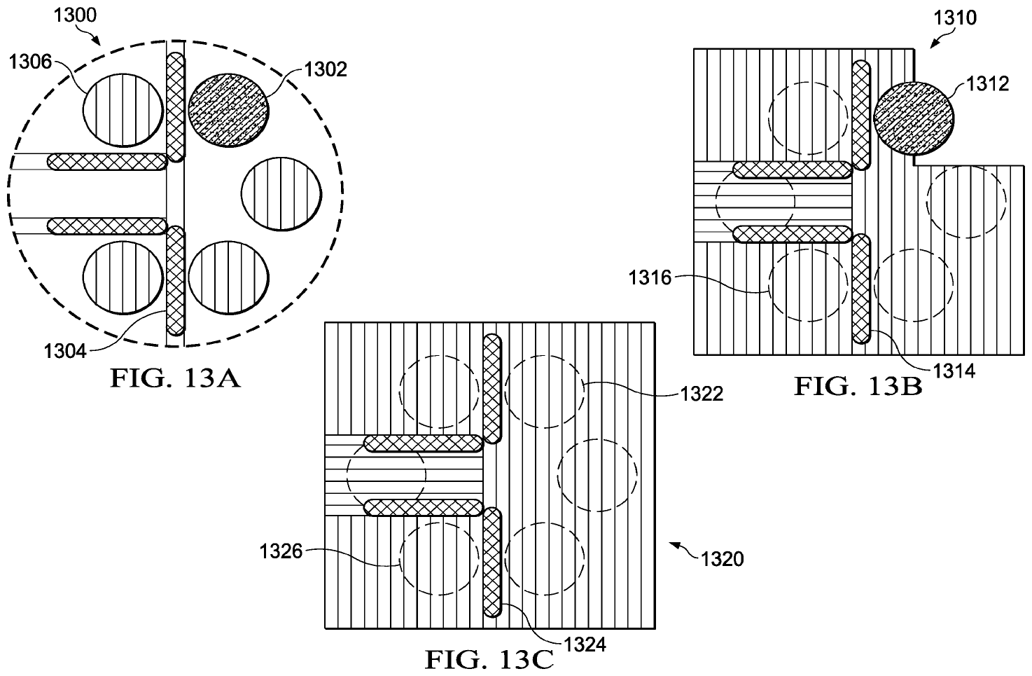

Based on how a specific color-absorbing resin dispenses (volume, viscosity, surface energy, charge, etc.) and spreads over specific nanopatterned surfaces, selected lithography methods and processes (e.g., e-beam, photolithography, imprint lithography such as J-FIL™, etc.) can be used to create and reproduce predefined nanopatterns on a substrate. Such predefined patterns can precisely guide the color-absorbing resin to a predefined shape within a small area. FIGS. 13A-13C depict various anti-reflective gratings defined lithographically and patterned with, for example, an IC diffractive grating on one or both sides of the substrate to guide color-absorbing resin into specific orientations. FIG. 13A shows an embodiment of world side super pupil 1300 with IC 1302 and color-absorbing regions 1304 having predefined (rectangular) shapes configured to block cross-illumination from incoupling of undesired colors from illumination sources 1306. Color-absorbing regions 1304 are and illumination sources 1306 have nanopatterned anti-reflective layers, which also act as guide patterns for shaping color-absorbing resin once dispensed and cured. Surrounding portions of super pupil 1300 are blank (not patterned). FIGS. 13B and 13C depict both sides (e.g., top and bottom) of super pupils 1310 and 1320, respectively. FIG. 13B shows an embodiment of world side super pupil 1310 with IC 1312 and color-absorbing regions 1314 having predefined (rectangular) shapes configured to block cross-illumination from incoupling of undesired colors from illumination sources 1316. Super pupil 1310, color-absorbing regions, and nanopatterned anti-reflective layer 1318 are one side of the super pupil, and the illumination sources 1316 are on an opposite side of the super pupil. FIG. 13C shows an embodiment of eye side super pupil 1320 with IC 1322 and illumination sources 1326 on one side of super pupil 1320, and color-absorbing regions 1324 and anti-reflective layer 1328 on an opposite side of super pupil 1320. Color-absorbing regions 1324 having predefined (rectangular) shapes configured to block cross-illumination from incoupling of undesired colors from illumination sources 1326.

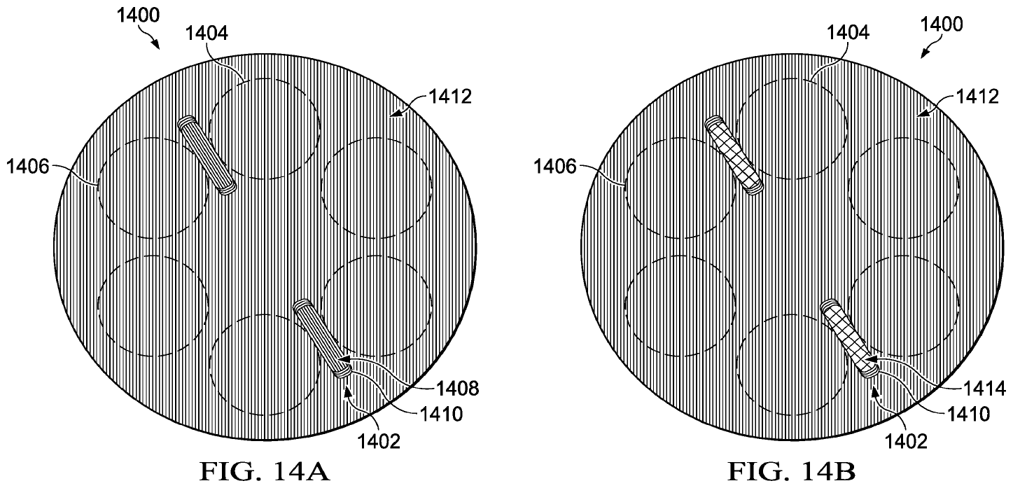

Additional examples of patterning super pupils are depicted in FIGS. 14A-14B through FIGS. 17A-17B.

FIG. 14A depicts super pupil 1400 with anti-reflective gratings covering its entire surface. Color-absorbing regions 1402 are formed in selected locations between IC 1404 and illumination sources 1406. Color-absorbing region 1402 is configured to absorb light from the illumination path outlined by illumination source 1406, which would have otherwise strayed into the area outlined by IC 1404 through direct overlap of the light cone and/or angular reflection of the illumination light reflecting and refraction off multiple surfaces of the multi-waveguide stack. This reflected/refracted light would have otherwise have made its way back into IC 1404 of another color, as discussed with respect to FIGS. 1A and 1B. Gratings 1408, 1410 that define the interior and perimeter, respectively, of color-absorbing regions 1402 are oriented differently than gratings 1412 in the rest of super pupil 1400 to control flow of color-absorbing resin. Gratings 1410 along the shorter side of color-absorbing regions 1402 are orthogonal to the direction of fluid flow and confine fluid in a region having a selected size and shape. FIG. 14B depicts color-absorbing resin 1414 contained in color-absorbing regions 1402.

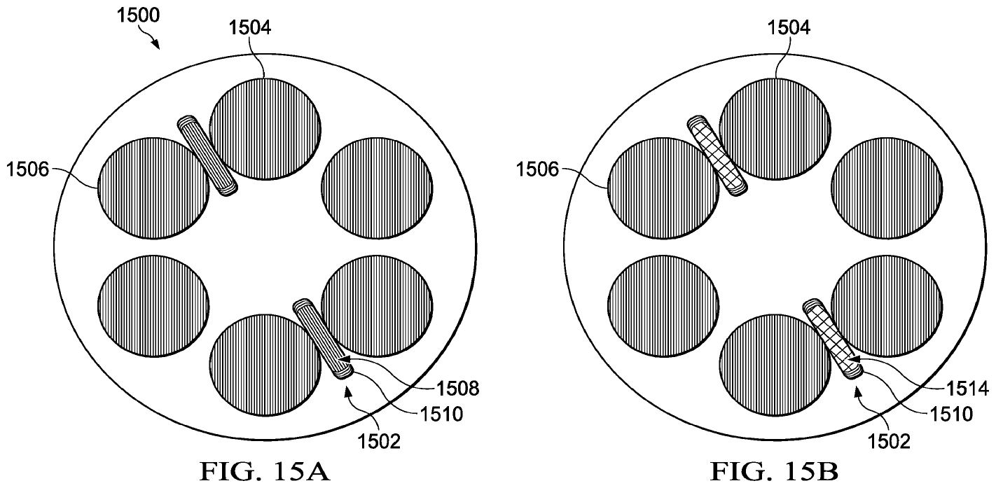

FIG. 15A depicts super pupil 1500 with anti-reflective gratings covering color-absorbing regions 1502 and IC and illumination sources 1504, 1506, respectively. Gratings 1508, 1510 that define the interior and perimeter, respectively, of color-absorbing regions 1502 are oriented differently than gratings on IC and illumination sources 1504, 1506 to control flow of color-absorbing resin. Gratings 1510 along the shorter sides of color-absorbing regions 1502 are orthogonal to the direction of fluid flow and confine fluid in a region having a selected size and shape. FIG. 15B depicts color-absorbing resin 1514 contained in color-absorbing regions 1502.

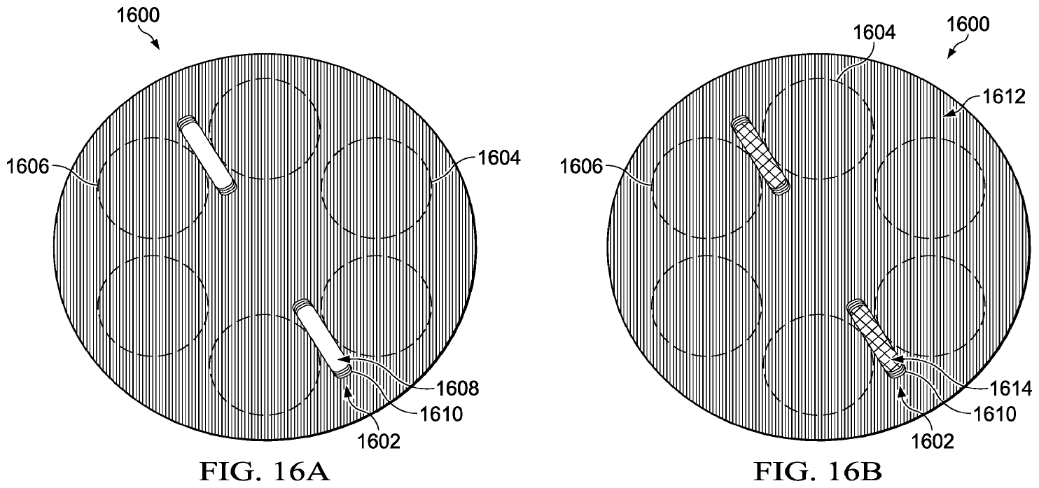

FIG. 16A depicts super pupil 1600 with anti-reflective gratings covering its entire surface. Color-absorbing regions 1602 are formed in selected locations between ICs 1604 and illumination sources 1606. Color-absorbing region 1602 is configured to absorb light from the illumination path outlined by illumination source 1606, which would have otherwise strayed into the area outlined by IC 1604 through direct overlap of the light cone and/or angular reflection of the illumination light reflecting and refraction off multiple surfaces of the multi-waveguide stack. This reflected/refracted light would have otherwise have made its way back into IC 1604 of another color, as discussed with respect to FIGS. 1A and 1B. Interior 1608 of color-absorbing regions 1602 is blank (not patterned). Gratings 1610 that define the perimeter of color-absorbing regions 1602 are oriented differently than gratings 1612 in the rest of super pupil 1600 to control flow of color-absorbing resin. Gratings 1610 along the shorter side of color-absorbing regions 1602 are orthogonal to the direction of fluid flow and confine fluid in a region having a selected size and shape. FIG. 16B depicts color-absorbing resin 1614 contained in color-absorbing regions 1602.

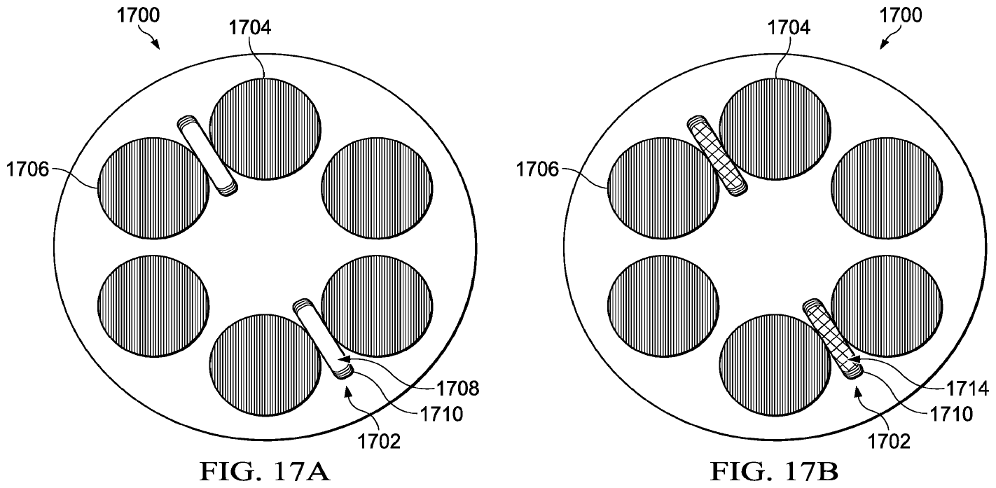

FIG. 17A depicts super pupil 1700 with anti-reflective gratings covering color-absorbing regions 1702 and IC and illumination sources 1704, 1706, respectively. Interior 1708 of color-absorbing region 1702 is blank (not patterned). Gratings 1710 that define the perimeter of color-absorbing regions 1702 are oriented differently than gratings on IC and illumination sources 1704, 1706 to control flow of color-absorbing resin. Gratings 1710 along the shorter sides of color-absorbing regions 1702 are orthogonal to the direction of fluid flow and confine fluid in a region having a selected size and shape. FIG. 15B depicts color-absorbing resin 1714 contained in color-absorbing regions 1702.

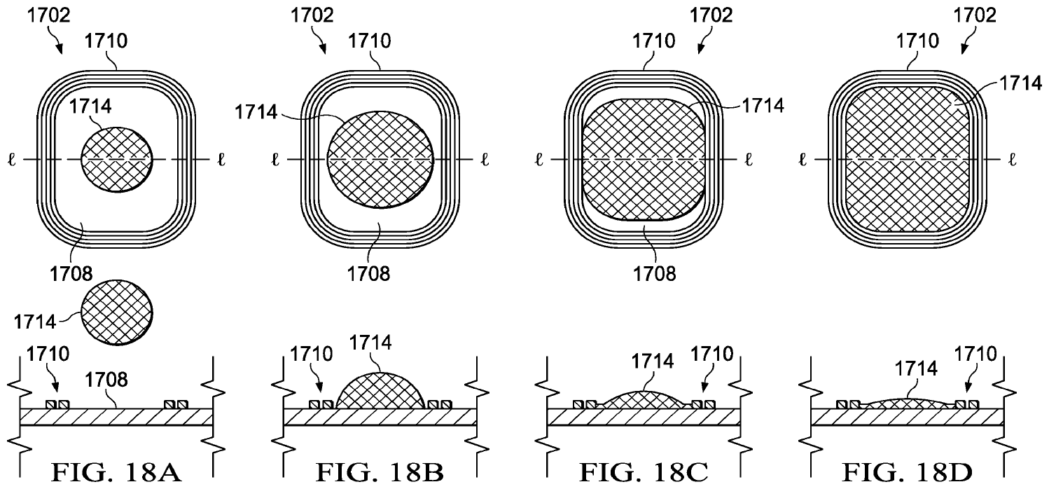

One or more drops of color-absorbing resin can be disposed in color-absorbing regions of a super pupil to fill the color-absorbing regions. FIGS. 18A-18D depict spreading of color-absorbing resin 1714 in color-absorbing regions 1702 (or 1602) of super pupil 1700 (or 1600). FIGS. 18A-18D (upper) show top views of color-absorbing region 1702 defined by gratings 1710. FIGS. 18A-18D (lower) show side cross-sectional views of color-absorbing regions 1702 along plane l-l orthogonal to gratings 1710. In FIG. 18A, a single large drop of color-absorbing resin 1714 is disposed in interior 1708 of color-absorbing region 1702. FIG. 18B depicts single drop of color-absorbing resin 1714 before it spreads in color-absorbing region 1702. FIG. 18C depicts single drop of color-absorbing resin 1714 as it begins to spread in color-absorbing region 1702, and FIG. 18D depicts single drop of color-absorbing resin 1714 after it has filled color-absorbing region 1702.

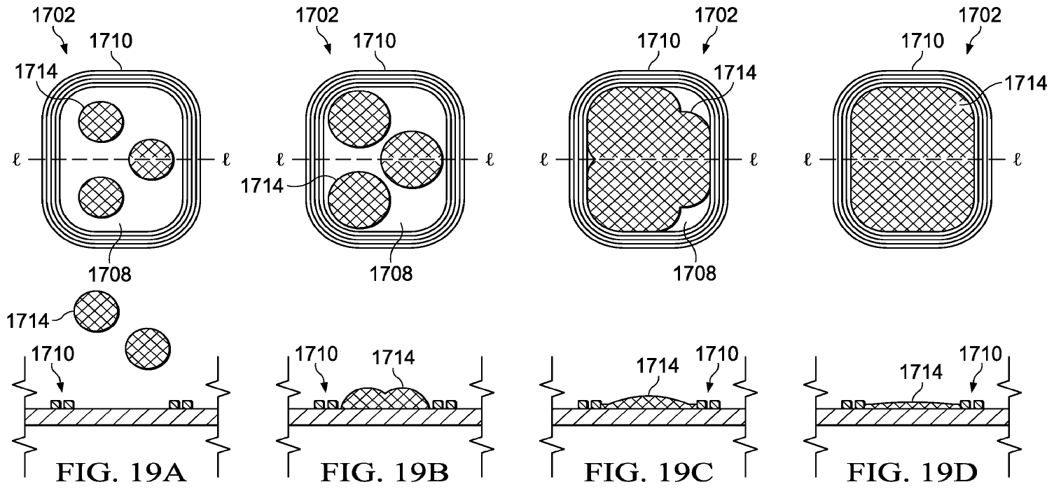

FIGS. 19A-19D depict spreading of color-absorbing resin 1714 in color-absorbing regions 1702 (or 1602) of super pupil 1700 (or 1600). FIGS. 19A-19D (upper) show top views of color-absorbing region 1702 defined by gratings 1710. FIGS. 19A-19D (lower) show side cross-sectional views of color-absorbing regions 1702 along plane l-l orthogonal to gratings 1710. In FIG. 19A, multiple drops of color-absorbing resin 1714 are disposed in interior 1708 of color-absorbing region 1702. FIG. 19B depicts multiple drops of color-absorbing resin 1714 before they spread in color-absorbing region 1702. FIG. 19C depicts multiple drops of color-absorbing resin 1714 as it begins to spread in color-absorbing region 1702, and FIG. 19D depicts multiple drops of color-absorbing resin 1714 after they have filled color-absorbing region 1702.

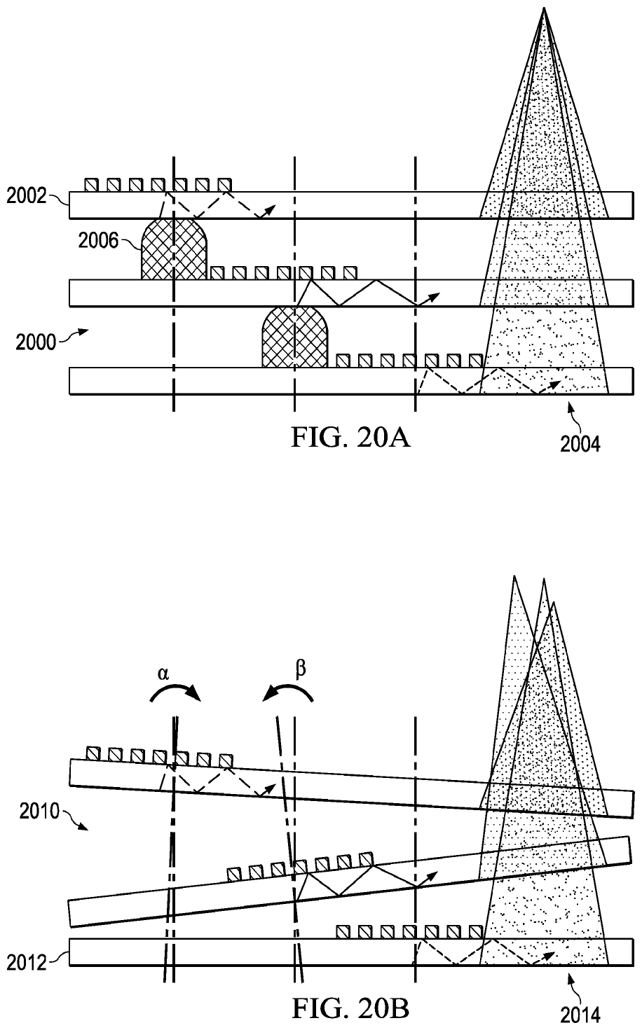

In some implementations, color-absorbing regions formed with or without fluid confinement are used as spacers between waveguides in a waveguide stack, thereby maintaining a uniform gap between ICs even when the waveguide stacks undergo stress or strain during assembly and use of an eyepiece under normal conditions or conditions of high heat or humidity. Gap control provided by the color-absorbing spacers around the ICs ensures a uniform distance between the projector and IC working distance and reduction in the angular shift of the virtual image propagating toward the output coupler. FIG. 20A depicts waveguide stack 2000 with waveguides 2002 and RGB illumination 2004 incident on waveguides 2002. Color-absorbing spacers 2006 maintain a uniform distance between waveguides 2002. In contrast, waveguide stack 2010 in FIG. 20B demonstrates non-uniform distances between waveguides 2012. These non-uniform distances shift the projector to IC angles α and β, thus affecting launch from the ICs.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A waveguide stack comprising:
a first waveguide comprising a first input coupler configured to couple light in a first wavelength range into the first waveguide;
a second waveguide coupled to the first waveguide and comprising a second input coupler configured to couple light in a second wavelength range into the second waveguide;
a first color-selective region on a side of the first waveguide opposite that of the first input coupler, wherein the first color-selective region is configured to absorb incident light in the second wavelength range, thereby preventing the incident light in the second wavelength range from entering the first waveguide through the first input coupler; and
a second color-selective region on a side of the second waveguide opposite that of the second input coupler, wherein the second color-selective region is configured to absorb incident light in the first wavelength range, thereby preventing the incident light in the first wavelength range from entering the second waveguide through the second input coupler.

2. The waveguide stack of claim 1, further comprising:
a third waveguide coupled to the second waveguide and comprising a third input coupler configured to couple light in a third wavelength range into the third waveguide; and
a third color-selective region on a side of the third waveguide opposite that of the second input coupler, wherein the third color-selective region is configured to absorb incident light in the second wavelength range, thereby preventing the incident light in the second wavelength range from entering the third waveguide through the third input coupler.

3. The waveguide stack of claim 2, further comprising a fourth color-selective region, on the side of the second waveguide opposite that of the second input coupler, wherein the fourth color-selective region is configured to absorb incident light in the third wavelength range, thereby preventing the incident light in the third wavelength range from entering the second waveguide through the second input coupler.

4. The waveguide stack of claim 1, wherein the first color-selective region comprises a polymeric region configured to absorb incident light in the second wavelength range.

5. The waveguide stack of claim 4, wherein the polymeric region has a shape and a size determined by an imprinted region on the side of the first waveguide.

6. The waveguide stack of claim 5, wherein the imprinted region comprises protrusions and recessions.

7. The waveguide stack of claim 5, wherein a shape of the imprinted region is rectangular, arcuate, chevron-shaped, or hourglass-shaped.

8. The waveguide stack of claim 1, wherein an interface between the first color-selective region and the first waveguide is patterned.

9. The waveguide stack of claim 8, wherein a side of the first color-selective region opposite the interface is convex, planar, or patterned.

10. The waveguide stack of claim 9, wherein the side of the first color selective region opposite the interface is anti-reflective.

11. An eyepiece comprising the waveguide stack of claim 1.

12. A method of forming a wavelength-selective region on a waveguide, the method comprising:
forming a recession on a portion of the waveguide proximate an input coupler, wherein the input coupler is configured to couple light in a selected wavelength range into the waveguide;
disposing a polymerizable composition in the recession, wherein the polymerizable composition is color-selective; and
polymerizing the polymerizable composition to yield the wavelength-selective region, wherein the wavelength-selective region is configured to absorb incident light on the input coupler other than light in the selected wavelength range.

13. The method of claim 12, wherein disposing the polymerizable composition in the recession comprises a continuous or discrete deposition of the polymerizable composition.

14. The method of claim 12, wherein the recession comprises a nanopattern.

15. The method of claim 14, wherein the nanopattern is selected to direct flow of the polymerizable composition on the waveguide.

16. The method of claim 12, wherein the recession is rectangular, arcuate, chevron-shaped, or hourglass-shaped.

17. The method of claim 12, further comprising, before polymerizing the polymerizable composition, contacting the polymerizable composition with a template.

18. The method of claim 17, wherein the template is nanopatterned or blank.

19. The method of claim 12, wherein the wavelength-selective region separates the input coupler from an additional input coupler.

20. The method of claim 12, wherein the recession comprises a patterned perimeter configured to retain the polymerizable composition in the recession.

21. The method of claim 12, wherein the recession comprises protrusions configured to direct a flow of the polymerizable composition in the recession.
